(19) United States
(12) Patent Application Publication
(10) Pub. No.: US 2013/0035973 A1
(43) Pub. Date: Feb. 7, 2013

(54) ASSESSING GREEN IT MATURITY AND PROVIDING GREEN IT RECOMMENDATIONS

(71) Applicants: Mitesh Ajitbhai Desai, Gujarat (IN); Vaibhav Bhatia, Bangalore (IN); Sujana Kolli, Hyderabad (IN); Arvind Raman, Bangalore (IN)

(72) Inventors: Mitesh Ajitbhai Desai, Gujarat (IN); Vaibhav Bhatia, Bangalore (IN); Sujana Kolli, Hyderabad (IN); Arvind Raman, Bangalore (IN)

(73) Assignee: Infosys Limited, Bangalore (IN)

(21) Appl. No.: 13/316,208

(22) Filed: Dec. 9, 2011

(30) Foreign Application Priority Data
Aug. 1, 2011 (IN) 2632/CHE/2011

(51) Int. Cl. G06Q 10/06

(52) U.S. Cl. 705/7.11

(57) ABSTRACT

A Green IT maturity model (GITM) provides a framework in which the maturity of an organization's green computing effort can be assessed. Based on green computing practice data, an assessment tool implementing a GITM model can be used to calculate the competency levels of multiple green computing pillars such as data center, end user computing, IT asset lifecycle, IT service management and people practices pillars. The determined competency levels can be used to determine a consolidated Green IT maturity level for the organization. A Green IT baseline of an organization can be determined and carbon emission reductions relative to the baseline can be used in determining the competency levels. The assessment tool can use the competency and maturity levels to recommend green computing initiatives and to estimate cost savings, implementation costs and carbon emission reductions for the recommended initiatives.

### BACKGROUND

Green IT (Information Technology) or green computing, refers to environmentally sustainable and environmentally friendly computing practices. Green IT encompasses practices related to, for example, the design, acquisition, management, use and disposal of computing resources that strive to reduce the carbon footprint of an organization's IT functions. Green IT practices include practices not only related to computing devices and peripherals such as purchasing more energy efficient devices and recycling older ones, but also practices related to the behavior of users, such as turning off computers at the end of a work day, using Internet telephony instead of conventional phones, and using videoconferencing instead of travelling to meet with a coworker or client.

Various IT management frameworks exist. These include the Information Technology Infrastructure Library (ITIL) and the COBIT framework created by the Information Systems Audit and Control Association (ISACA). Various process improvement models are also known. One such model is the Capability Maturity Model Integration (CMMI) model.

### SUMMARY

This Summary is provided to introduce a selection of concepts, in a simplified form, that are further described hereafter in the Detailed Description. This Summary is not intended to identify key features or essential features of the claimed subject matter nor is it intended to be used to limit the scope of the claimed subject matter.

A Green IT maturity model (GITM) is disclosed that provides for an assessment of the maturity of an organization's green computing or Green IT practices. The model determines a competency or maturity level for various aspects or “pillars” of the organization's IT functions. These pillars encompass both tangible and intangible aspects of an organization in order to provide a holistic view of the organization's Green IT maturity. The tangible aspects include an organization's data center (data center pillar), end user computing (end user computing pillar), the lifecycle of IT assets (IT asset lifecycle pillar). The intangible aspects include the management of IT services (IT services management pillar), and the practices, environmental awareness and behavior of end users and other employees within the organization (people practices pillar).

A Green IT maturity level for the organization as a whole is determined from the pillar competency levels, and can be the minimum pillar competency level. Thus, in order for an organization to reach higher levels of Green IT maturity, the organization can undertake efforts to implement green computing practices across various aspects of the organization.

In one embodiment, a Green IT assessment tool receives green computing practice data that indicates whether an organization has implemented various green computing practices. The tool determines competency levels for the pillar and calculates a Green IT maturity level for an organization. The tool recommends various green computing initiatives that the organization can implement to reach higher competency and maturity levels.

In other embodiments, the assessment tool can receive an inventory of IT assets and, for the recommended initiatives, provide estimates of operational cost savings, implementation costs, energy consumption savings and carbon emission reductions based on the inventory. The assessment tool can also receive carbon emissions goals (for example, a 50% reduction in carbon emissions in three years) and budget constraints for an organization and provide a package of recommended initiatives that offer estimated carbon emission reduction savings that would achieve those goals and fit within the budget constraints.

The foregoing and other objects, features and advantages of the invention will become more apparent from the following detailed description, which proceeds with reference to the accompanying figures.

### BRIEF DESCRIPTION OF THE DRAWINGS

FIG. 1 is an exemplary Green IT maturity model.

FIG. 2 is a block diagram of an exemplary system for assessing the maturity of an organization's green computing practices.

FIG. 3 is a block diagram of an exemplary Green IT assessment tool.

FIG. 4 is an illustration of an exemplary spreadsheet within a Green IT assessment tool for assessing the competency level of an end user computing pillar.

FIG. 5 is an illustration of an exemplary spreadsheet within a Green IT assessment tool comprising inventory related questions associated with an end user computing pillar.

FIG. 6 is a flowchart of a first exemplary method of assessing the Green IT maturity of an organization.

FIG. 7 is a flowchart of an exemplary method of estimating energy savings and carbon emission reductions for data center and end user computing pillars.

FIG. 8 is a flowchart of an exemplary method of calculating estimated energy savings and carbon emission reductions for a people practices pillar.

FIG. 9 is a flowchart of a second exemplary method of assessing the maturity of an information technology (IT) organization's green computing efforts.

FIG. 10 illustrates a generalized example of a suitable implementation environment in which described embodiments, techniques, and technologies may be implemented.

### DETAILED DESCRIPTION

A Green IT maturity model (GITM) is disclosed that provides for the assessment of the maturity of an organization's green computing or Green IT practices. The model determines a competency or maturity level for various aspects or “pillars” of the organization. These pillars encompass both tangible and intangible aspects of an organization in order to provide a holistic view of the organization's Green IT maturity. The tangible aspects include an organization's data center (data center pillar), end user computing (end user computing pillar), the lifecycle of IT assets (IT asset lifecycle pillar). The intangible aspects include the management of IT services (IT services management pillar), and the practices, environmental awareness and behavior of end users and other employees within the organization (people practices pillar).

### EXAMPLE 1

### Exemplary Green IT Maturity Model

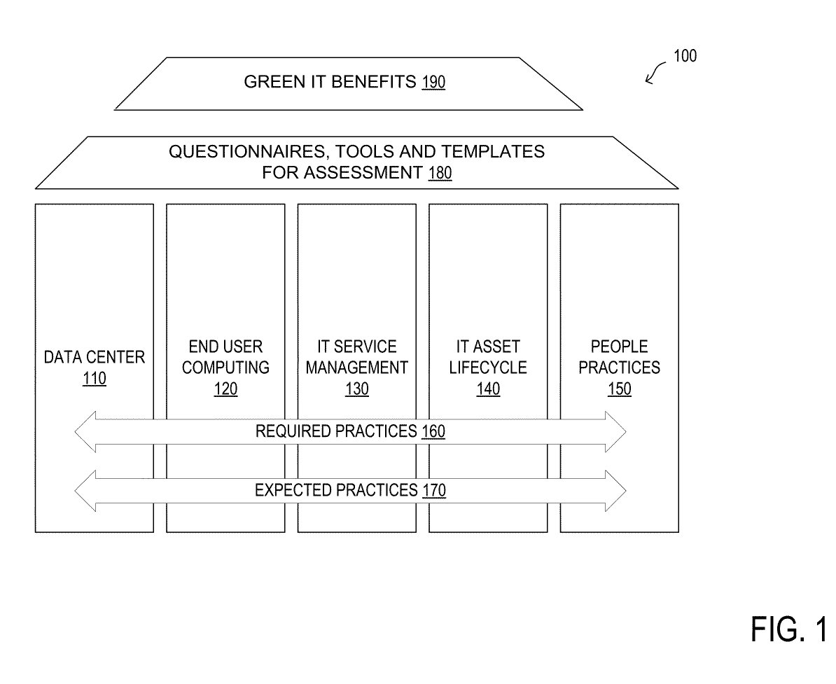

FIG. 1 shows a Green IT maturity model (GITM) 100 for assessing the green computing efforts (Green IT efforts, or simply, Green IT) of an organization. The organization can be an information technology (IT) organization or an organization having IT functions. The Green IT maturity of an organization is based on the assessed green computing competency or maturity levels for individual aspects or “pillars” of the organization, which cover both tangible and intangible aspects of green computing. The model 100 comprises five pillars: a data center pillar 110, an end user computing pillar 120, an IT service management pillar 130, an IT asset lifecycle pillar 140 and a people practices pillar 150.

A pillar has associated with it a set of green computing practices comprising required practices (or components) 160 and expected practices (or components) 170. The required practices 160 comprise green computing practices that are to be in place in order for the organization to reach a given competency level for a given pillar, and the expected practices 170 comprise practices that the organization can implement to reach a higher competency level. Although the model 100 comprises five pillars, a green IT maturity model can contain more or fewer pillars. The model further comprises questionnaires, tools and templates for use in collecting green computing practice data 180, and the realized green computing benefits 190 that can be realized by implementing green computing initiatives recommended by Green IT assessment tools implementing the model Green IT model 100.

### EXAMPLE 2

### Exemplary Competency and Maturity Levels

The model 100 comprises five competency levels for a pillar, the competency levels indicating levels of green computing maturity within a pillar. Green IT maturity is a measure of the green computing practices that have been implemented within an organization. The consolidated Green IT maturity or Green IT maturity for an organization is the minimum of the assessed pillar competency levels. That is, in order for an organization to achieve a specified Green IT maturity, the competency level for the pillars must also be at least at the same level. The maturity level G_{M} for an organization can be expressed by the formula:

G_{M}=min(C_{L}(DC), C_{L}(AL), C_{L}(ITS), C_{L}(EU), C_{L}(PP)),

where C_{L}=competency level and DC=data center pillar, AL=IT asset lifecycle pillar, ITS=IT service management pillar, EU=end user computing pillar and PP=people practices pillar. Thus, for an IT organization having an assessed competency level of level 3 for the data center, end user computing and

IT service management pillars, and an assessed competency level of level 4 for the asset lifecycle and people practices pillar, the Green IT maturity for the organization would be level 3. A Green IT maturity model can comprise more or fewer competency and maturity levels, both for the organization as a whole and for the individual pillars.

For the five maturity levels in the Green IT maturity model 100, the levels can have the associated following characteristics (which roughly follow the characteristics of maturity levels in the CMMI framework).

Maturity Level 5—Sustainable, Continually optimizing, Innovative. At level 5, an IT organization is focused on process improvement and can be expected to assist in reducing an overall business's carbon footprint. The initiatives or practices in place in order for an IT organization to reach the level 5 competency/maturity level can involve, for example, the automation of manual or paper-intensive activities, and assessing business processes for possible green computing improvements.

Maturity Level 4—Dynamic, Quantitatively Managed, Integrated. At level 4, Green IT results are reported to stakeholders through sustainability reports. Typically, an organization that has reached level 4 maturity is approaching carbon neutrality with respect to its IT activities.

Maturity Level 3 Optimized, Defined. At level 3, an organization typically has dedicated Green IT personnel. Typically, an organization that has reached level 3 maturity has reduced the carbon footprint of its IT operations by approximately 50% (relative to a baseline in which no green IT practices have been implemented).

Maturity Level 2—Monitored, Managed. At level 2, an IT organization has begun to measure its environmental impact and has implemented some green computing initiatives or practices. Typically, organizations reaching level 2 maturity have reduced the carbon emissions of its IT operations by approximately 10% (relative to a baseline in which no green IT practices have been implemented).

Maturity Level 1—Initial/Ad hoc. At level 1, an organization has started assessing the benefits of Green IT but has not yet implemented, or has implemented only a small number, of green computing practices.

### EXAMPLE 3

### Exemplary Data Center Pillar Competency Levels

In any of the examples described herein, an organization can reach a given competency level for a given pillar by implementing a specified set of green computing practices (i.e., required practices or components) associated with a given competency level—pillar pair. The data center pillar pertains to an IT organization's data center and facilities and can have the following competency levels having the following characteristics.

Data Center Competency Level 5 (DC5)—Building sustainable infrastructure through innovative practices. At competency level 5, the data center green computing practices in place can include, for example, the data center obtaining its power from renewable energy sources and implementation of a Self-healing IT infrastructure. A self-healing IT infrastructure is one that can automatically adjust to changes in its environment. For example, a self-healing IT infrastructure can automatically turn on a secondary air conditioning unit when the primary air conditioning fails.

Data Center Competency Level 4 (DC4)—Utilizing automation to provision infrastructure components. At competency level 4, the data center green computing practices in place can include, for example, the dynamic allocation and de-allocation of data center resources (such as power, cooling, IT services) based on client or user demand, time of day, etc. Sensor-based technology can be utilized for dynamic cooling and lighting of the data center. For example, the data center environment can be allowed to be at higher or cooler temperatures, or have the lights turned off, on the weekends and evenings if there are no people around, with the lights being turned on and the temperature set to a level comfortable for people if there are personnel present the data center during off-shift hours.

Data Center Competency Level 3 (DC3) Optimizing IT infrastructure to reduce energy consumption and carbon emissions. At competency level 3, the data center green computing practices in place can include, for example, the use of virtualization technologies and optimal sever placement to reduce cooling requirements. The use of virtualization technologies can reduce the amount of hardware needed to provide a given level of software services to IT end users. For example, virtualization technologies can enable software services that are to be provided to 100 users to be provided by 30-40 servers rather than 100 computers or servers if virtualization technologies were not used.

Data Center Competency Level 2 (DC2)—Monitoring energy consumption and implementing low cost green computing practices. At competency level 2, the data center green computing practices in place can include, for example, the monitoring of energy used and heat dissipated by devices in the data center and taking appropriate corrective actions, and tracking the business requirements of IT resources and taking corrective actions. Business requirements of IT resources pertain to IT resources being allocated to specific business functions or organizations within a business. At competency level 2, computing practices are in place such that when a business function or organization no longer requires the dedicated IT resources, the resources are turned off so that they do not continue to consume energy.

Data Center Competency Level 1 (DC1)—implementing fundamental initiatives. At this level, there is typically minimal management of IT resources. Some green computing practices that can be implemented at competency level 1 include, for example, cooling in adherence with the American Society of Heating, Refrigerating and Air-Conditioning (ASHRAE) standards, and the manual monitoring of energy consumption.

### EXAMPLE 4

### Exemplary End User Computing Competency Levels

The end user computing pillar pertains to end user computing devices such as laptops, desktop, printers, etc. and can have the following competency levels having the following characteristics.

End User Computing Competency Level 5 (EC5)—Building sustainable IT infrastructure through innovative practices. At competency level 5, the end user computing Green IT practices in place can include, for example, employing end user computing devices and technologies such as video conferencing to reduce carbon footprint of the IT organization or business.

End User Computing Competency Level 4 (EC4)—Utilizing automation to dynamically provision infrastructure components. At competency level 4, the end user computing Green IT practices in place can include, for example, the dynamic provision of end user computing resources. End user computing resources can be dynamically provided by, for example, virtual desktop infrastructure technologies.

End User Computing Competency Level 3 (EC3)—Optimizing the IT infrastructure to reduce energy consumption and carbon emissions. At competency level 3, the end user computing Green IT practices in place can include, for example, the optimization of existing IT resources by technologies such as centralized power management. The IT organization can also be using multi-function devices.

End User Computing Competency Level 2 (EC2)—Monitoring energy consumption and implementing low cost green computing practices. At competency level 2, the end user computing Green IT practices in place can include, for example, monitoring the power consumption of end user computing devices and implement low cost or low effort practices such as disabling screen savers, and enabling sleep settings for monitors and CPUs.

End User Computing Competency Level 1 (EC1)—Implementing fundamental initiatives. At competency level 1, the end user computing Green IT practices in place can include, for example, the sharing of printers, scanners and copier devices. In some embodiments, IT organizations can have implemented a user to device ratio of approximately 250:1.

### EXAMPLE 5

### IT Service Management Competency Levels

The IT service management pillar pertains to the maturity of green computing practices pertaining to the management of IT services and can have the following competency levels having the following characteristics.

IT Service Management Competency Level 5 (IT5)—Enabling sustainable IT service management through innovative practices. At competency level 5, service-based carbon management is implemented by the IT organization and the ff service management green computing practices in place can include, for example, the utilization of service improvement plans for continual reduction in carbon emission of IT.

IT Service Management Competency Level 4 (IT4)—Dynamic reporting on green computing adherence to IT service management processes. At competency level 4, the IT service management green computing practices in place can include, for example, the incorporation of Green ff checkpoints in various IT service management processes and measuring adherence to these checkpoints at regular intervals. Green IT checkpoints are practices or actions that can be included in a process that provide information useful to Green IT personnel in making decisions regarding energy consumption and carbon emission reductions. Some examples of Green IT checkpoints include calculating the estimated carbon emissions and energy consumption for new IT services that are to be introduced, considering the use of efficient IT infrastructure technologies such as virtualization technologies, and performing an environmental impact assessment of planned or considered changes in the IT infrastructure. Green IT checkpoints can include reporting any generated results (e.g. estimated carbon emission reductions, environmental impact assessment) to Green IT personnel.IT Service Management Competency Level 3 (IT3)—Implementing a Green IT governance structure and increasing the use of automation. At competency level 3, the IT service management green computing practices in place can include, for example, the automation of IT service management processes using various software packages, the incorporation of Green IT metrics for IT service management into the software tools, and the formation of a Green IT governance body (such as dedicated Green IT personnel or a Green IT department) to ensure efficient implementation of green IT initiatives.

IT Service Management Competency Level 2 (IT2)—Defining Green IT metrics for IT service management processes. At competency level 2, the IT service management green computing practices in place can include, for example, the employment of metrics (e.g., the amount of paper used, energy consumed) to measure environmental impact of IT services. These metrics can be reported to management to manage development of the IT organization's Green IT strategy.

IT Service Management Competency Level 1 (IT1)—Automating critical IT service management processes. At competency level 1, the IT service management green computing practices in place can include, a few IT service management processes are automated and the processes do not have specific inputs for Green IT. For example, at competency level 1, a configuration management database for tracking IT resources may be implemented but not integrated with an incident tracking (e.g., ticketing) system. In such a case, the incident resolution team may have to manually identify troubled devices, which may involve team members having to travel to a remote data center.

### EXAMPLE 6

### IT Asset Lifecycle Competency Levels

The IT asset lifecycle pillar pertains to the maturity of green computing practices pertaining to the lifecycle of IT assets, from procurement to end-of-life. Assessment of asset life cycle competency levels can include, for example, an assessment of the purchasing process of an organization. This assessment can include assessing the environmental and sustainability practices of the supplier. The IT asset lifecycle pillar can have the following competency levels having the following characteristics.

IT Asset Lifecycle Competency Level 5 (AL5)—Enabling sustainable handling of assets beyond the scope of the organization. At competency level 5, the IT asset lifecycle green computing practices in place can include, for example, certification of the IT organization's suppliers' business processes for sustainable practices. For example, the IT organization can ensure that waste vendors dispose of IT assets in an environmentally friendly manner and the suppliers use environmentally sustainable sources for their materials or environmentally friendly manufacturing processes.

IT Asset Lifecycle Competency Level 4 (ALA)—Optimizing management of IT assets. At competency level 4, the IT asset lifecycle green computing practices in place can include, for example, the formation of policies for managing IT assets such as the purchase of IT assets, the replacement (refreshment) of IT assets and/or the storage of IT assets.

IT Asset Lifecycle Competency Level 3 (AL3)—Spreading awareness on asset lifecycle perspective among relevant stakeholders. At competency level 3, the IT asset lifecycle green computing practices in place can include, for example, assessing and documenting the environmental impact of the asset lifecycle phase and document them, and spreading awareness about the impacts among the asset management and procurement teams to ensure appropriate handling of assets.

IT Asset Lifecycle Competency Level 2 (AL2)—Understanding and curtailing the impact of the pre-use phase of an asset's lifecycle on the environment. At competency level 2, IT asset lifecycle green computing practices in place can include, for example, optimizing how often IT assets are replaced and optimizing the procurement process in order to reduce environmental impact. For example, the procedure to determine when IT assets are to replaced can consider the difference in energy efficiencies between new computing devices and those currently being used, the environmental costs of disposing of the old assets, and the environmental costs associated with the manufacture and transportation of the new IT assets.

IT Asset Lifecycle Competency Level 1 (AL1)—Introducing energy efficient devices. At competency level 1, the IT service management green computing practices in place can include, for example, purchasing energy efficient devices when new IT assets are purchased.

### EXAMPLE 7

### People Practices Competency Levels

The people practices pillar pertains to the behavior, environmental awareness and practices of employees of an organization or of a business. Studies suggest that user awareness of green computing practices can offer up to twice the energy savings as compared to centralized power management solutions. The people practices pillar can have the following competency levels having the following characteristics.

People Practices Competency Level 5 (PP5)—Utilizing people awareness to spread environmental awareness in other functional units or outside the business. At competency level 5, green computing practices relating to people practices that are in place can include, for example, the implementation of tiatives to utilize employee awareness to spread awareness of green practices, which can include green computing practices, to business units and employees outside of the IT organization. For instance, an IT organization of a bank or a. retail store can spread environmental awareness to its customers through splays or flyers; a business can provide the use of its facilities for weekend environmental camps and awareness to other organizations; and a business can encourage or require its customers to receive electronic statements and annual reports in place of paper ones.

People Practices Competency Level 4 (PP4)—Aiding employee-initiated. Green IT initiatives. At competency level 4, green computing practices relating to people practices that are in place can include, for example, supporting employee-initiated green computing initiatives and including employees in the green IT governing body.

People Practices Competency Level 3 (PP3)—Ensuring user participation in organization's environmental initiatives. At competency level 3, green computing practices relating to people practices that are in place can include, for example, initiating various environmentally-related initiatives in organization that are governed by the green IT governing body. Such initiatives can include encouraging users to turn off their computing devices and peripherals at the end of the day, before going home for the weekend, before leaving on vacation, when they are out of the office for lunch or away from the office for a meeting, etc.

People Practices Competency Level 2 (PP2)—Monitoring user awareness of green computing. At competency level 2, green computing practices relating to people practices that are in place can include, for example, monitoring user awareness through multiple channels like on-line quizzes, competitions and open forum discussions (e.g., on-line user forums relating to green computing practices)

People Practices Competency Level 1 (PP1)—Initiation of green computing practices user awareness campaign. At competency level 1, employees may be reluctant to accept or understand environmental issues at this stage. Green computing practices relating to people practices at this level can include, for example, communication to organization employees about internal green computing initiatives and the effects that green computing practices can have on the environment.

### EXAMPLE 8

### Exemplary System for Assessing Green IT Maturity Model

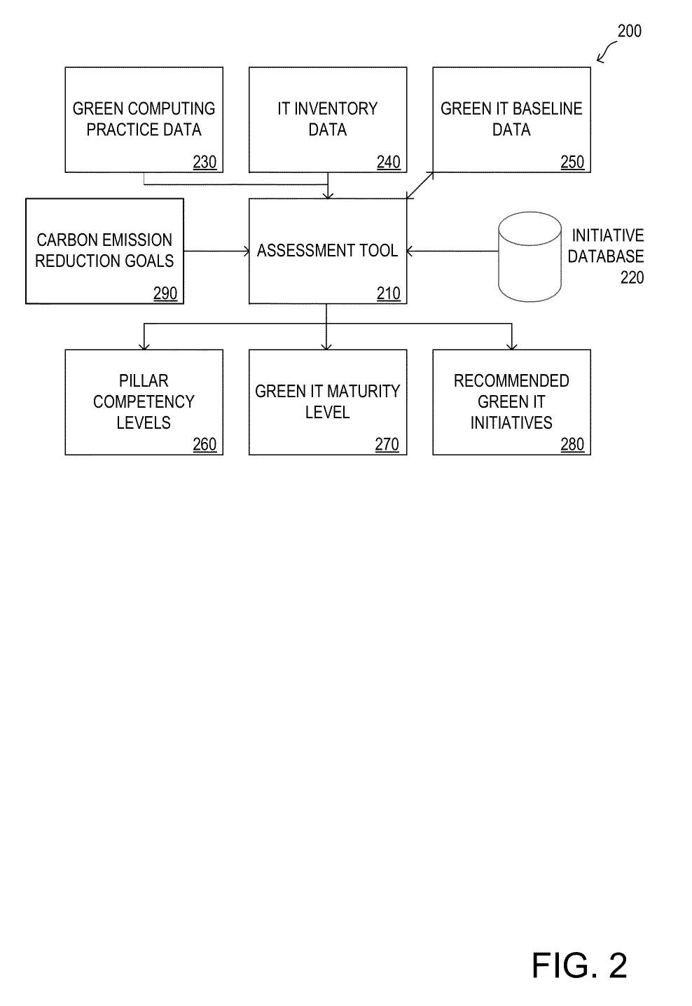

FIG. 2 is a block diagram of an exemplary system 200 for assessing the maturity of an organization's green computing (Green IT) practices. The system 200 comprises an assessment tool 210 and a green computing initiative database 220. The assessment tool 210 receives green computing practice data 230, IT inventory data 240 and Green IT baseline data 250 and generates pillar competency levels 260, a Green IT maturity level 270 for an organization and recommended Green IT initiatives 280. The system 200 can optionally receive carbon emission reduction goals 290.

### EXAMPLE 9

### Exemplary Assessment Tool

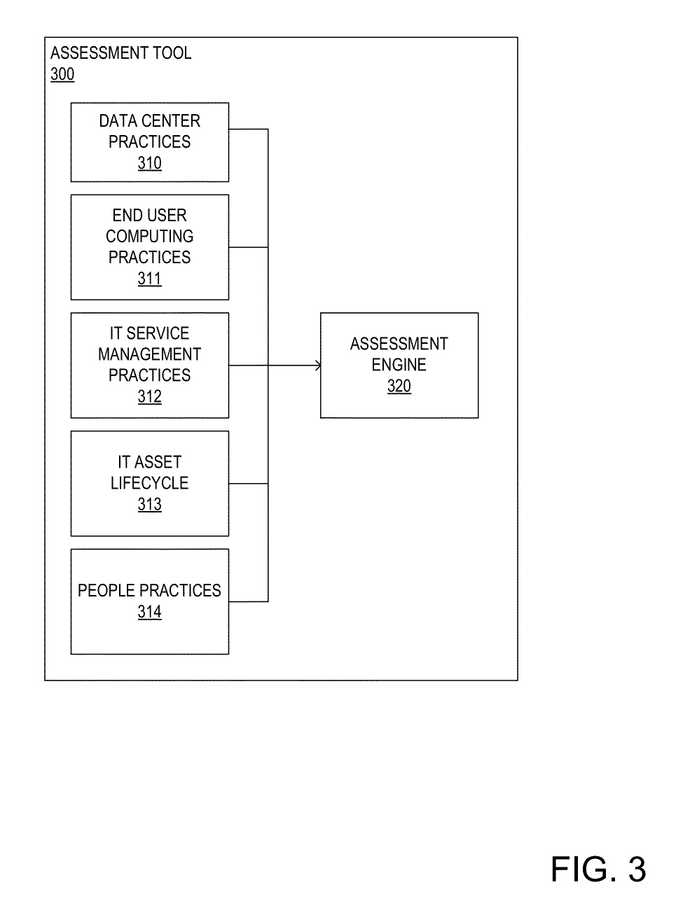

FIG. 3 shows a block diagram of an exemplary Green IT assessment tool 300 comprising green computing practices or Green IT practices 310-314 for the five pillars shown in FIG. 1 and an assessment engine 320. The green computing pillar practices 310-314 are used in assessing the received green computing practice data to determine the pillar competency levels and an organization's Green IT maturity level. The assessment tool can be implemented as a software application executed, as a spreadsheet that operates within a spreadsheet application or the like. The green computing practices can be part of the assessment tool 300, as shown, or stored in a database that is accessible to the tool. The green computing practices 310-314 are dynamic and expandable. That is, the green computing practices 310-314 can change as green computing standards evolve and new Green IT practices become available.

### EXAMPLE 10

### Exemplary Green Computing Practice Data

In any of the examples described herein, spreadsheet embodiments of the assessment tool can comprise separate sheets configured to receive and analyze green computing practice data to determine a competency level for the pillars within a Green IT model.

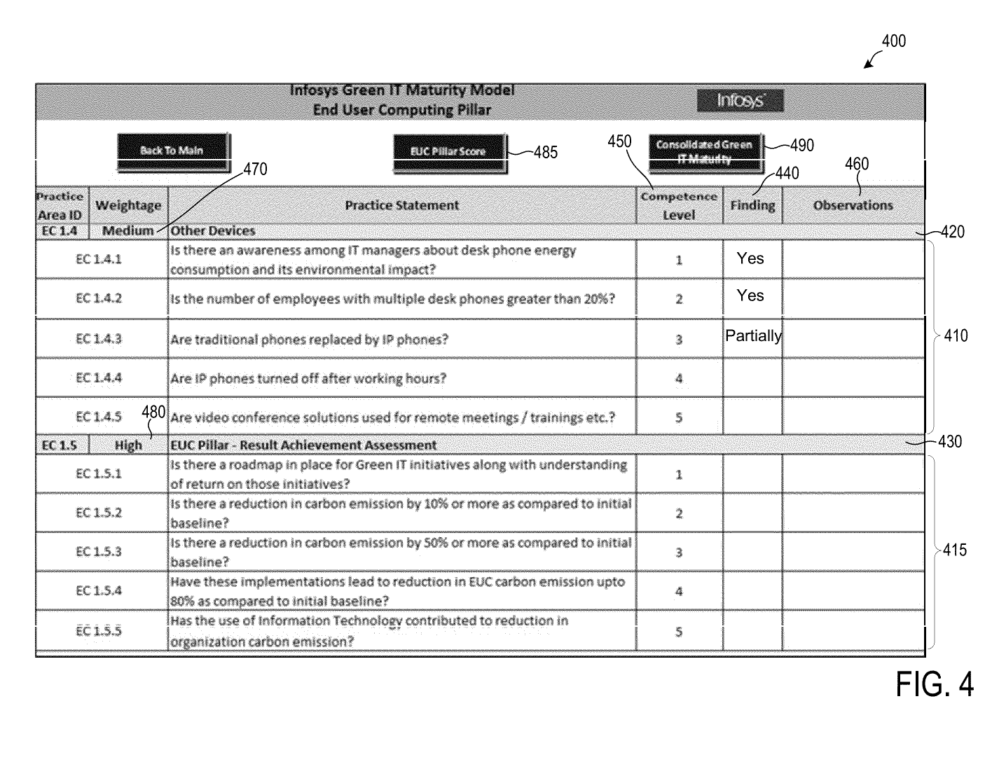

FIG. 4 shows an exemplary spreadsheet 400 for receiving end user computing green computing practice data and determining the competency level of an end user computing pillar. The spreadsheet 400 comprises practices 410 and 415 associated with practice areas 420 and 430. The spreadsheet 400 is configured to accept data in the finding column 440 indicating whether the practices are implemented by an organization. The data supplied in the finding column 440 is based on green computing practice data. Some analysis or assessment of green computing practice data may be required in order to determine whether green computing practices are implemented, as determining whether green computing practices are implemented may not be readily determinable, for example, through questionnaires supplied to end users. Spreadsheet 400 is configured to accept values of “Yes,” “Partially” or “NA” for the green computing practices in the finding column 440. In alternative embodiments, the spreadsheet can be configured to accept other finding values.

In some embodiments, the green computing practice data can be supplied directly to the assessment tool and the tool can automatically determine whether certain green computing practices are fully or partially implemented. For example, if individual users are asked to fill out an on-line questionnaire to collect green practice computing data related to end user computing, and the questionnaire queries the users whether they have multiple desk phones, the assessment tool can determine whether the number of employees with multiple desk phones is greater than 20% (practice EC 1.4.2).

The competence level column 450 indicates which competence level the green computing practices are associated. For example, practice EC 1.4.3, “Are traditional phones replaced by IP phones?” is associated with competence level 3. Thus, in an assessment tool comprising spreadsheet 400, this green computing practice, along with practice EC 1.5.3, is to be implemented by an organization before that organization reaches a competency level of 3 for the end user computing pillar. Although one practice is shown as being associated with a given competency level in spreadsheet 400, a competency level can be associated with any or none of the practices within a practice area. Additional comments and observations regarding the individual green computing practices can be provided in the observations column 460.

The spreadsheet 400 is configured to allow different practice areas to have different weightings, such as low, medium or high. For example, practice area 420 has a weighting 470 of medium and practice area 430 has a weighting 480 of high. The weightings indicate the relative weight to be accorded a practice area when the competency and maturity levels are determined. Thus, practices belonging to practice area 430 carry greater weight in determining the competency level relative to practices belonging to practice area 420. In one embodiment, the assessment tool can be configured to allow users to indicate weightings of low, medium or high, having relative weighs of 0.75, 1.0 and 1.25, respectively.

The spreadsheet 400 also comprises clickable buttons 485 and 490 that, when clicked, calculate the end user computing pillar score and route the user to a consolidated green IT maturity sheet within the spreadsheet, respectively.

### EXAMPLE 11

### Exemplary End User Computing Green Computing Practices

The spreadsheet 400 shows green computing practices 410, 415 for practice areas 420, 430 in the end user computing pillar. An assessment tool can determine the competency level for an end user computing pillar based on one or more of the following practices and practice areas.
Practice Area: Desktop/Laptop Management
   Competency Level 1 green computing practices:
      Is there awareness among IT managers about computing device (e.g., desktop, laptop, server) energy consumption and the environmental impact thereof?
   Competency Level 2 green computing practices:
      Is computing device energy consumption tracked centrally?
      Has the organization stopped or substantially reduced the use of screensavers?
      Are all or a majority of the computing devices in the organization energy efficiency certified (e.g., Energy Star qualified)?
      Are optimal sleep settings implemented for all or a majority of the computing devices in the organization?
   Competency Level 3 green computing practices:
      Are any initiatives or technologies implemented for central control of computing device energy consumption?
   Competency Level 4 green computing practices:
      Are technology solutions such as virtual desktop infrastructure/desktop as a service used for further reduction of energy consumption implemented?
   Competency Level 5 green computing practices:
      Are computing devices equipped with webcams and are the webcams used for video calls to avoid travel?
      Are computing device users equipped with accessories to enable improved cooling and provide a more ergonomic style of working?
      Are desktop computers provided with appropriate monitors to reduce strain on eyes?
Practice Area: Printer/MF Device Management Practices
   Competency Level 1 green computing practices:
      Is there awareness among IT managers about printers/scanners/multifunctional device (MFD) energy consumption and the environmental impact thereof?
   Competency Level 2 green computing practices:
      Is printer, scanners, and MFDs energy consumption tracked centrally?
      Are all or a majority of printers, scanners and MFDs in organization energy efficiency certified?
      Are network printers used instead of individual printers in the organization? If yes, what is the ratio of users to device?
      Are all or a majority of printers or MFDs used in economy mode?
      Are all or a majority of printers configured for duplex printing?
   Competency Level 3 green computing practices:
      Are all or a majority of printers configured for secure printing or “private” jobs?
      Are optimal sleep settings implemented for all or a majority of printers, scanners and multifunctional devices (MFDs) in the organization?
      Are all or a majority of printers, copiers and scanners replaced with MFDs?
      If scanned images are stored on storage devices connected to the network, are the storage devices cleaned (i.e., temporary files are deleted according to a data retention policy) at regular intervals?
   Competency Level 4 green computing practices:
      Is a centralized solution in place to track and control the number of pages printed by users?
   Competency Level 5 green computing practices:
      Are business processes analyzed and improvements implemented to reduce the use of paper?
Practice Area: Other Devices
   Competency Level 1 green computing practices:
      Is there awareness among IT managers about desk phone energy consumption and the environmental impact thereof?
   Competency Level 2 green computing practices:
      Is the number of employees with multiple desk phones greater than 20%?
   Competency Level 3 green computing practices:
      Are traditional phones replaced by IP phones?
   Competency Level 4 green computing practices:
      Are IP (Internet Protocol) phones turned off after working hours?
   Competency Level 5 green computing practices:
      Are video conference solutions used for remote meetings, training etc.?
Practice Area: Result Achievement Assessment
   Competency Level 1 green computing practices:
      Is there a roadmap in place for Green IT initiatives along with an understanding of the return on those initiatives?
   Competency Level 2 green computing practices:
      Is there a reduction in carbon emission by 10% or more as compared to the initial baseline?
   Competency Level 3 green computing practices:
      Is there a reduction in carbon emission by 50% or more as compared to the initial baseline?
   Competency Level 4 green computing practices:
      Have these implementations lead to reduction in end user computing carbon emission up to 80% as compared to the initial baseline?
   Competency Level 5 green computing practices:
      Has the use of Information Technology contributed to reduction in the organization's carbon emission?

Additional green computing practices and practice areas can be used as well.

### EXAMPLE 12

### Exemplary Green Computing Practice Data

In any of the examples described herein, green computing practice data comprises data that reflects the extent to which green computing initiatives and practices are implemented by an organization. The green computing practice data comprises data that allows for a determination of whether individual green practices are being implemented within an organization (i.e., the practices 410 and 415 in spreadsheet 400). For example, green computing practice EC 1.4.3 “Are traditional phones replaced by IP phones?” can be determined by individual employees completing a questionnaires asking whether they have a traditional phone at their desk, and if they do, how often they use the traditional phone versus an IP phone.

The green computing practice data can be collected via questionnaires or surveys completed by the organization's employees, interviews of the employees by personnel performing the Green IT maturity assessment, monitoring of employee's practices and behavior by green IT consultants, reviews of procedures related to IT computing and the like. For example, determining whether green computing practice EC 1.4.5, “Are video conference solutions used for remote meetings/trainings etc.?” has been implemented can be done by individual employees indicating in a questionnaire whether they have participated in meetings or training using video conferencing, a green IT staff member or consultant reviewing meeting and training policies for an organization or reviewing usage reports generated by video conferencing software.

Green computing practice data can be collected manually such as with paper questionnaires or electronically such as with on-line surveys. The green computing practice data can be collected by the Green IT maturity assessment tool directly, or the green computing practice data can be analyzed independent from the tool. For example, the “End User Computing Pillar—Result Achievement Assessment” practice area allows for the reduction of carbon emissions to be included in the assessment of the end user computing pillar in an organization's Green IT assessment. The tool assessment can be configured such that specified carbon emission reductions are to be met before an organization can reach a certain competency level.

An organization's IT-related processes can be analyzed as part of collecting the green computing practice data. Steps within processes can be analyzed in relation to other steps within the same process or across processes within or outside the organization, as processes can have an impact on other processes and changing one step in a process can have an impact downstream. The number of steps in IT-related processes can be determined as well, as reducing the number of steps in a process can result in processes with a reduced environmental impact.

### EXAMPLE 13

### Exemplary IT Inventory Data

In any of the examples described herein, IT inventory data can be collected and provided to an assessment tool. The tool can use the IT inventory data to establish a carbon emission baseline (Green IT baseline) from which carbon emission reductions due to the implementation of green computing practices can be determined. IT inventory data can include the quantity, make and model, usage patterns and age of computing devices (e.g., desktops, laptops, servers, netbooks, notebooks) and peripherals (e.g., printers). IT inventory data can also comprise power management settings on computing devices and peripherals, paper usage, the number of people working in a shift within the organization, shift start and end times, shift lengths, the number of personal computers that are not turned off at the end of working hours and the like. IT inventory data is not limited to physical and human capital and can also include information pertaining to an organization's businesses practices and procedures such as whether a data center operated by the organization is fully owned or shared, whether IT assets are owned or licensed and the like.

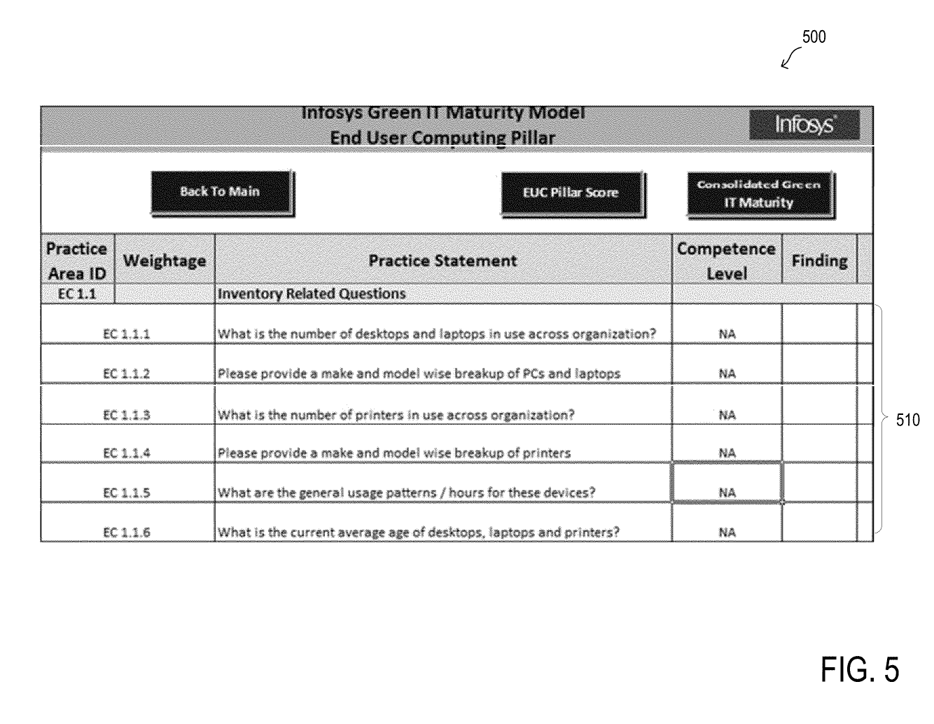

FIG. 5 shows an exemplary spreadsheet 500 of a Green IT maturity assessment tool comprising inventory related questions 510 that are to be answered during end user computing pillar assessment. The inventory data can be provided as input to the assessment tool and the tool can determine carbon emission estimates, or, as shown in FIG. 5, the assessment tool can provide inventory related questions that serve as a reminder to the personnel performing the assessment what inventory data is to be captured. Carbon emission reductions relative to a baseline can be included as green computing practices within an assessment tool (i.e., questions 510 within spreadsheet 500). For example, a reduction in carbon emissions of at least 10%, 50% or 80% can be required before an organization has an assessed competency level of 1, 2 or 3, respectively. Alternatively, carbon emission reduction levels can be included in the competency level analysis, but not be a hard requirement for an organization to reach a given competency level.

### EXAMPLE 14

### Exemplary Green IT Baseline

In any of the examples described herein, an assessment tool can determine a Green IT baseline against which carbon emission reductions resulting from the implementation of Green IT practices are measured. The Green IT baseline can be determined when an organization first performs a Green IT maturity assessment, which can be prior to an organization implementing green computing practices. Or, a Green IT baseline can be determined at some point after the organization has already implemented green computing practices and wishes to identify further green computing initiatives for realizing additional carbon emission reductions. Thus, an organization's Green IT baseline can be determined when an organization has been deemed to be at a maturity level other than level 1. Accordingly, the carbon emission reduction goals that can be included as part of the Green IT maturity assessment can be scaled according to the initial baseline. For example, if a Green IT maturity assessment indicates that an organization has a Green IT maturity of level 2, the assessment tool can be configured such that carbon emission reductions of only, for example, 30% (instead of, for example, 50%) are required for the organization to obtain level 3 Green IT maturity.

### EXAMPLE 15

### Exemplary Carbon Emission Reduction Goals

In any of the examples described herein, a Green IT assessment tool can recommend green computing initiatives based on an organization's carbon emission reduction goals. A carbon emission reduction goal can be provided in absolute or relative terms, and over a certain time period. One example of a carbon emission reduction goal is an 80% reduction in carbon emissions over 5 years.

An assessment tool can be configured to have Green IT maturity be determined based on additional or alternative environmental goals such as a reduction in energy consumption or paper consumption, portion of energy provided from renewable sources and the like. For example, the Result Achievement Assessment practice area in the end user computing pillar can be modified to query whether these additional or alternative environmentally related goals are met.

Typically, a Green IT maturity model includes at least one quantifiable measure of the impact of implementing green computing practices has on the environment (e.g., reduced carbon emissions, reduced paper usage). In alternative embodiments, the Green IT maturity model does not include such quantifiable measures and an organization's Green IT maturity level is based on whether specified green computing initiatives have been implemented.

### EXAMPLE 16

### Exemplary Green Computing Initiatives

In any of the embodiments described herein, green computing initiatives can be recommended for implementation based on the pillar competency levels and an organization's overall Green IT maturity. The recommended initiatives can be provided by an assessment tool or independently of a tool. The green computing initiatives can comprise green computing practices associated with pillar competency levels that the organization has not yet achieved. For example, with reference to spreadsheet 400 in FIG. 4, if an organization has reached a competency level 2 for the end user computing pillar, the recommended initiatives can include the green practices 410 and 415 associated with competency levels 3 through 5. Thus, the assessment tool could recommend that the organization replace traditional phones with IP phones (practice EC 1.4.3), that IP phones are turned off after working hours (practice EC 1.4.4) and that video conference solutions are used for remote meetings and training (EC 1.4.5). Green computing initiatives in addition the green practices that are included in an assessment tool for assessing Green IT maturity (e.g., practices 410 and 415) can be recommended as well.

Recommended initiatives in addition to those disclosed elsewhere herein include switching to cloud computing software, and switching to a data storage provider that has a smaller carbon footprint than a current data storage provider.

The recommended green computing initiatives can be stored in an initiative database accessible to the assessment tool. The initiatives stored in the database can comprise industry-wide accepted best practices and standards. The database is dynamic and can be updated as, for example, Green IT industry standards evolve, government incentives for business that implement green computing practices become available, and more energy efficient computing devices are offered and renewable energy sources become more readily available or decrease in price. The green computing initiatives database can comprise a list of IT asset suppliers along with information indicating the suppliers' own green practices and any environmental benefits that can be realized by procuring IT assets from the various suppliers. The database can be updated as IT asset suppliers exit and enter the market, their product offerings change or as the suppliers' environmental practices change. As part of recommending initiatives involving the procurement of IT assets, a list of suppliers offering the recommended IT assets can be provided, and an organization can select from the greener suppliers.

The green computing initiatives database can be updated to reflect the evolution of green computing practices industry-wide. For example, a green computing practice that is currently associated with competency level 5 for a given pillar may be associated with a lower competency level as green computing technologies and practices evolve and technologies and practices providing greater carbon emission reductions become available.

An assessment tool can automatically perform a Green IT maturity assessment periodically or whenever the initiative database is updated, in order for an organization to take advantage of initiatives recently added to the initiative database.

In some embodiments, estimations of cost savings and implementation costs can be provided for the recommended initiatives. The estimated cost savings can include savings due to reduced data center energy consumption, reduced hardware needs due to the use of virtualization technologies, reduced supply costs (e.g., paper) and the like. Implementation costs can include the costs of acquiring new IT assets such as more energy efficient desktops, laptops or servers.

An assessment tool can also be configured to accept budget information, and can use this information in selecting and presenting the recommended initiatives. For example, the tool can recommended initiatives that satisfy the provided budget constraints, or the tool can provide recommended initiatives without regard to budget considerations but present the recommended initiatives sorted by estimated implementation cost or operational cost savings. In some embodiments, the tool can sort recommended initiatives based on expected operational expense savings per implementation costs. That is, the tool can sort the initiatives by which initiatives give the greatest return on a certain level of investment.

Similarly, the assessment tool can provide estimated carbon emission reductions for the recommended initiatives. The estimated carbon emission reductions can be based on IT inventory data as well as information contained in the initiative database. For example, if a recommended initiative is to switch to more energy efficient computing devices, the assessment tool can estimate the reduction in carbon emission due to replacing the computers based on usage conditions in the IT inventory data for the new computers. The carbon reduction estimates can also account for the carbon footprint of disposing old computers and manufacturing new ones, reduced cooling costs resulting in the use of more energy efficient computers and the like. The initiative database can also contain carbon emission information for various energy sources used to power a data center, expected energy savings on a per user basis resulting from various changes in user behavior, the expected energy requirements for various computing devices and the like.

The initiative database can also include information on the amount of energy consumed by various IT devices. For example, the database can contain the average energy consumed by desktops, laptops and other computing devices of various makes. The energy consumption information can include an average (estimated or measured) energy consumption for a device under typical usage patterns, or more specific energy consumption information, such as when the device is operated under more specific usage patterns or is operating in a given state (e.g., on, running specific software applications, sleep mode). This information can be used to calculate current energy consumption levels of the IT resources currently in place and energy consumption levels of recommended green computing initiatives.

In some embodiments, the tool can recommend a package of one or more green computing initiatives having associated carbon emission reduction estimates, the sum of which is greater or equal to a carbon emission reduction goal.

The recommended initiatives can also be presented in the form of a roadmap. A roadmap can comprise one or more recommended initiatives and a recommended sequence in which the initiatives can be employed. The roadmap can also contain suggested periods over which the initiatives can be implemented.

### EXAMPLE 17

### Exemplary Green IT Assessment Deliverables

In any of the embodiments described herein, a Green IT assessment tool can generate deliverables that include an inventory report, competency levels for the various pillars, a Green IT maturity level for the organization, recommended Green IT initiatives that an organization can implement to improve pillar competency and Green IT maturity levels, roadmaps for implementing the recommended initiatives to achieve the organization's carbon emission reduction (or other environmentally-related metric) goals and the like.

For example, any of the Green IT assessment tools can provide an inventory report containing an inventory of the IT assets being utilized by an organization and the numbers of assets of each type.

The Green IT assessment tool can also produce a Green IT assessment report that contains the assessed competency level for the pillars and the Green IT maturity level for the organization. The report can contain energy consumption estimates and carbon emission estimates for the organization's IT assets based on asset type (computer, printer, etc.), specific make and usage patterns. The assessment report can contain recommended Green IT initiatives and for the recommended initiatives, can provide the expected reduction in carbon emissions, as described above. The assessment report can contain any other information described herein pertaining to recommended initiatives such as operation costs savings and implementation cost estimates.

The deliverables can be output to the display of a computing device, printer, multi-functional device or any other output device. The deliverables can also be stored on computer-readable storage media.

### EXAMPLE 18

### Exemplary Green IT Maturity Assessment

In one case study, the tools and technologies described herein were used to assess the Green IT maturity of an IT organization comprising data center servers, 900 desktop computers, 5 printers, and 3 scanners. Green computing practice data was collected and entered into an assessment tool to determine the competency levels of data center and end user computing pillars.

The Green IT maturity models assessed the data center and end user computing pillars to be at a competency level of 1. The tool estimated that annual energy savings of 22% could be achieved by replacing existing computing devices and that additional energy savings could be realized by implementing the automated shutdown of computing devices at the end of the working day, and by changing user behavior (e.g., having the users turn off their computers when leaving the office and configuring their computers to optimal sleep settings). The tool also estimated that energy costs could be reduced by 5% due to the reduced amount of energy needed to cool the data center.

### EXAMPLE 19

### Exemplary Implementation of Recommended Green IT Initiatives

In any of the examples described herein, recommended initiatives that lend themselves to automation can be implemented by other software applications. For example, the assessment tool can remotely configure end user computing devices to automatically shut down at the end of the working day, if the computing devices are remotely configurable. The assessment tool can also send recurring calendar notices or email remainders at the end of the working day or work week to remind users to turn off their computing devices before they go home, to implement a people practices pillar green computing initiative. Other recommended Green IT initiatives can be automatically implemented by the assessment tool such as remotely configuring printers and multifunctional devices to operate in an “economy” mode, deploying software to end user computing devices and peripherals that monitor usage patterns and deploying VoIP (Voice over IP) applications to enable IP telephony and videoconferencing. In some embodiments, the assessment tool can supply information to other software applications that automatically implement recommended green computing initiatives.

Recommended initiatives that may not be capable of being automatically implemented (e.g., modifications to an organization's business practices) can be implemented by an organization's Green IT personnel. If the Green IT maturity assessment was performed by Green IT consultants, the organization's Green IT staff can work with the Green IT consultants to select which recommended initiatives are to be implemented and how best to implement the selected initiatives. For example, the consultants can aid the organization in selecting which virtualization software or energy efficient computing devices an organization should purchase.

### EXAMPLE 20

### Exemplary Method of Assessing Green IT Maturity of an Organization

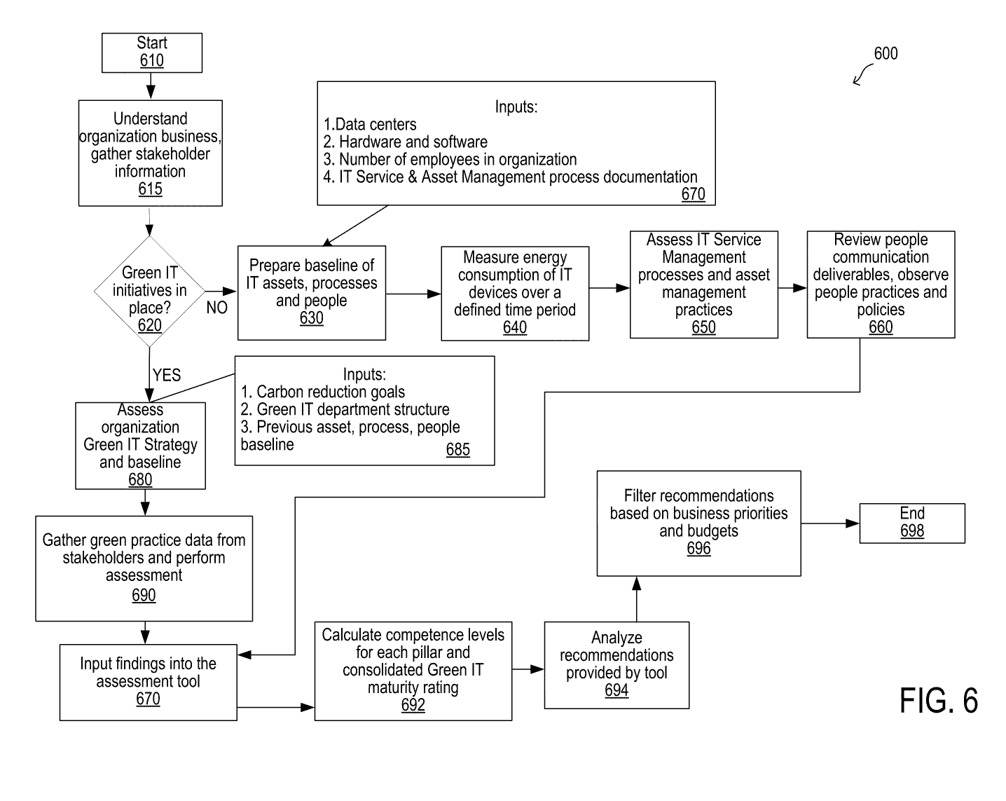

FIG. 6 is a flowchart of a first exemplary method 600 for assessing the Green IT maturity of an organization. The method 600 starts at 610. At 615, stakeholder information is gathered and the organization's business is understood. Green IT stakeholders can include an organization's Chief Information Officer (CIO), Chief Technology Officer (CTO), IT managers, IT users, marketing managers and the like. Stakeholder information includes such information as the stakeholder's role in the organization, the impact that they have on Green IT programs (e.g., the scope of their authority, their job responsibilities, their level of expertise), the potential impact of Green IT initiatives on the stakeholder, and the ability of the stakeholder to contribute to Green IT initiatives (e.g., due to budget or time constraints). At 620, if Green IT initiatives are not in place, the method 600 proceeds to 630 where a baseline of IT assets, processes and people is prepared. Baseline preparation can accept inputs 670 such as information pertaining to data centers, hardware (e.g., types, quantity, make and model, usage patterns), software applications, the number of employees in an organization, IT service and asset management process documentation, as well as any IT inventory information described herein.

At 640, the energy consumption of IT devices over a defined time period is measured and captured. At 650, IT service management processes and assessment management practices are assessed. At 660, people communication deliverables (e.g., flyers, emails, videos) are reviewed and people practices and policies and observed. At 670, the findings from 640, 650, 660 are input into a Green IT maturity assessment tool.

If Green IT initiatives are in place at 620, the method 600 proceeds to 680 where an organization's Green IT strategy and baseline are assessed. The inputs 685 can include the organization's carbon emission reduction goals (and any other environmentally related goals), the structure of a Green IT department within an organization (e.g., how many people are in the department, the scope of their responsibilities, the department's budget constraints) and the organization's previous baseline of IT assets, processes and people. At 690, green computing practice data is collected from stakeholders. The practice data can be collected via documents, questionnaires, observation, on-line surveys and the like. The collected data is then assessed and input into the assessment tool at 670.

At 692, competence levels for the pillars and a consolidated Green IT maturity rating for the organization is determined. At 694, green computing initiatives recommendations provided by the tool are analyzed and filtered based on factors such as business priorities and budget constraints. The method 600 then ends at 698. In some embodiments, the method 600 can further include implementing one or more of the recommended green computing initiatives.

### EXAMPLE 21

### Exemplary Method of Estimating Energy Savings and Carbon Emission Reductions for Data Center and End User Computing Pillar Green IT Initiatives

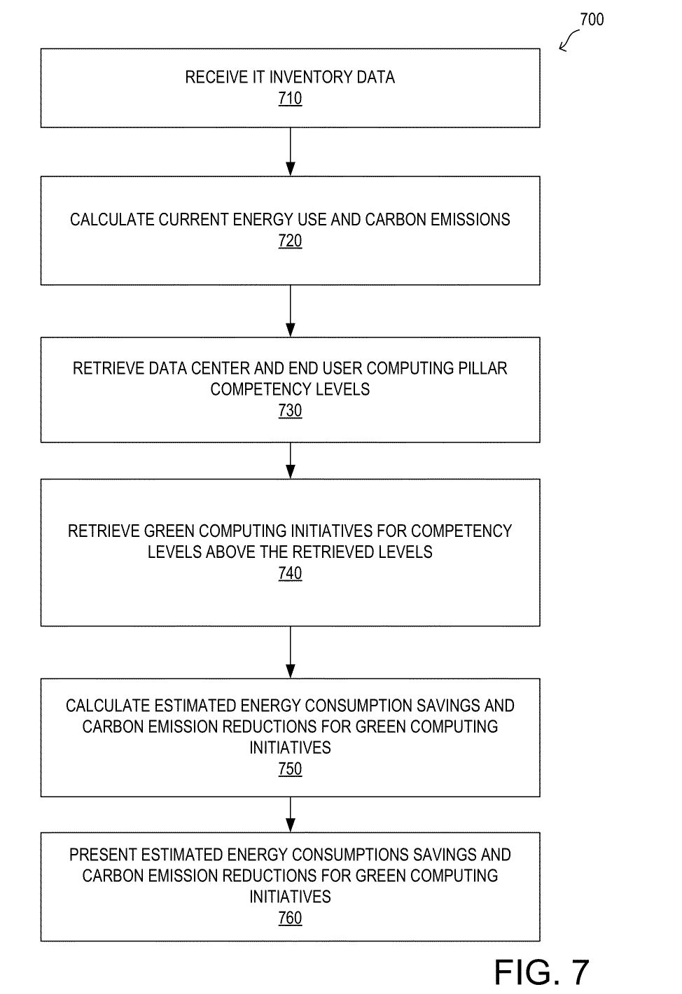

FIG. 7 is a flowchart of an exemplary method 700 of estimating energy savings for data center and end user computing pillar green computing initiatives. At 710, IT inventory data such as the number, type (e.g., desktop computer, laptop computer) and make of IT devices, along with utilization statistics and usage patterns are received. The received IT inventory data can include any other IT inventor data described herein. At 720, the present energy usage and carbon emission values are calculated. The energy usage values can be calculated based on the IT inventory data and can be based at least in part on measured energy consumption data as well. From the energy consumption data, carbon emission levels can be calculated based on information such as the type of energy source (e.g., fossil fuel, renewable energy) and number of IT computing devices.

At 730, the maturity level for the data center and the end user computing pillars is retrieved, based on an established Green IT baseline. At 740, green computing initiative information is retrieved for competency levels above the retrieved maturity and competency levels. The retrieved green computing initiative information can comprise estimated energy savings and carbon emission reductions on a green computing initiative basis or on a per device basis. For example, green computing initiative information can contain estimated average energy consumption levels for energy efficient devices or estimated carbon emissions per unit of energy of power consumed for a given energy source.

At 750, estimated energy consumption savings and carbon emission reductions for the green computing initiatives are calculated. The estimated savings and reductions are calculated based on IT inventory data and the retrieved green computing initiative information. For example, for a retrieved green computing initiative of replacing IT computing devices with more energy efficient models, the estimated energy savings can be based on the difference between the estimated energy usage of a more efficient design and the energy usage of the current devices multiplied by the number of devices in the IT inventory data. At 760, the estimated energy savings and carbon emission reductions are presented by the tool for the retrieved green computing initiatives.

### EXAMPLE 22

### Exemplary Method of Estimating Energy Savings and Carbon Emission Reductions for People Practices Pillar Green IT Initiatives

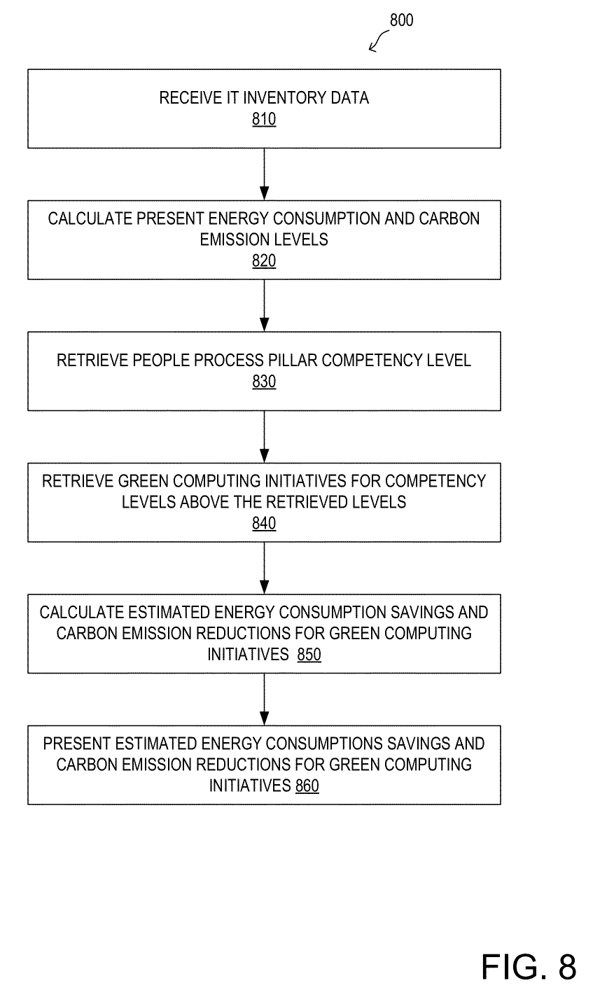

FIG. 8 shows an exemplary method 800 of estimating energy savings and carbon emission reductions for Green IT initiative pertaining to the people practices pillar. At 810, IT inventory data relating to people practices is received. People practices data can include, for example, the habits of users of IT computing device assets such as how often they turn off their computers when they leave work at the end of the day. At 820, the present energy consumption and carbon emission levels are calculated. At 830, the competency level for the people practices pillar and Green IT maturity level for the organization is retrieved. At 840, green computing initiatives are retrieved for competency levels above the retrieved maturity level for the IT organization and the competency levels for people practices pillar. At 850, estimated energy consumption savings and carbon emission reductions for the retrieved Green IT computing practices are calculated. The estimated savings and reductions can be calculated based on the IT inventory data and the retrieved computing practices information. At 860, the estimated energy savings and carbon emission reductions are presented by the tool for the retrieved green computing initiatives.

### EXAMPLE 23

### Exemplary Method for Assessing Green IT Maturity

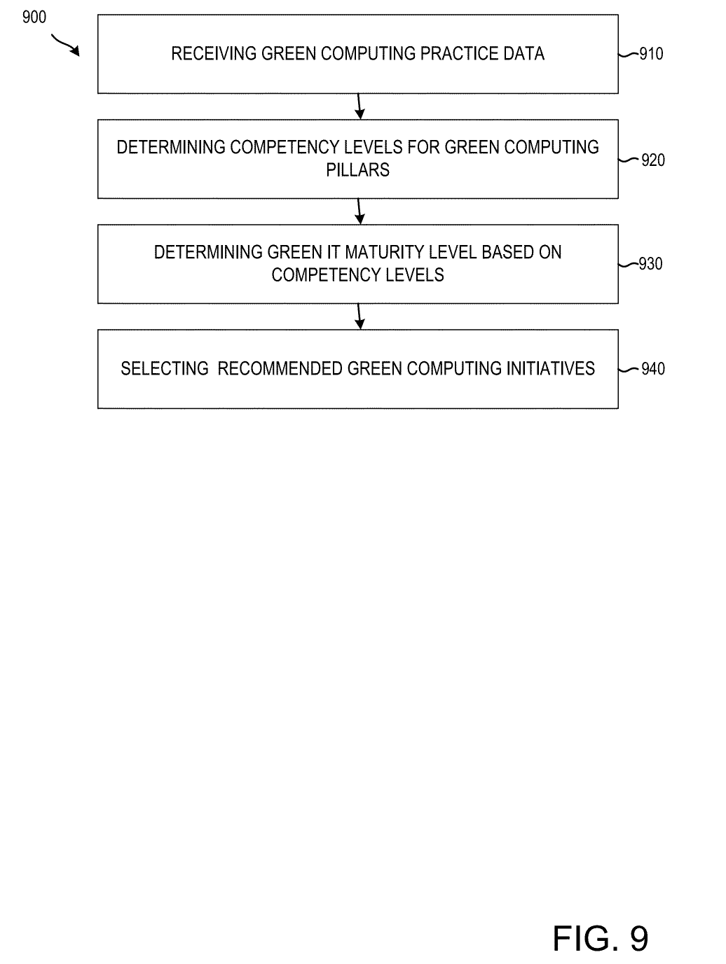

FIG. 9 is a flowchart of a second exemplary method 900 for assessing the maturity of an organization's green computing efforts.

At 910, green computing practice data is received indicating whether the organization has implemented one or more green computing practices out of a plurality of green computing practices. The green computing practices are associated with a plurality of green computing pillars.

At 920, a plurality of competency levels for the plurality of green computing pillars are determined based at least in part on the green computing practice data.

At 930, a green IT maturity level is determined based on the competency levels.

At 940, one or more recommended green computing initiatives are selected from a green computing initiative database based on at least the plurality of competency levels or the green IT maturity level.

### EXAMPLE 24

### Exemplary Utility of Green IT Maturity Models

Using tools and technologies described herein, the maturity of an organization's green computing practices can be assessed and green computing initiatives can be recommended. The recommended initiatives can then be used as part of a roadmap for the organization to follow to realize their carbon reduction goals.

Thus, by using the tools and techniques described herein, organizations can improve their “triple bottom line;” that is, their economic, environmental and societal performance. The Green IT maturity model can assist in improving an organization's economic performance by providing estimations of economic gains through the implementation of recommended green computing practices. These economic gains can result from, for example, lower energy costs through the use of more energy efficient devices, the reduced use of the IT assets (e.g., computers are turned off when employees leave for the day), and purchasing fewer assets (e.g., virtualization technologies can allow a certain level of software service to be provided using less hardware).

Environmental performance can be improved through the implementation of recommended green computing practices that result in the organization leaving a smaller carbon footprint. Societal performance can be improved as well. Increased awareness of environmental issues by an organization's employees can lead employees to behave in a more environmentally responsible manner outside of the work place. Implementing the recommended green computing practices can also allow a business to tout its environmental ethos, which can allow the organization to differentiate itself from competitors.

Further, the tools and technologies described herein can identify which pillars of an IT organization are the most deficient in the area of green computing. That is, the tools and techniques can identify where investment in green computing practices may yield the greatest dividends.

As computing devices are ubiquitous in the workplace, the tools and technologies described herein can be used by non-IT organizations. For example, organizations having employees that regularly use computing devices to perform their work can employ Green IT maturity models having at least an end user computing pillar and people practices pillar to assess the maturity of their green computing practices.

### EXAMPLE 25

### Exemplary Computing Environment

The techniques and solutions described herein can be performed by software and/or hardware of a computing environment, such as a computing device. Exemplary computing devices include server computers, desktop computers, laptop computers, notebook computers, netbooks, tablet devices, mobile devices, smartphones and other types of computing devices. The techniques and solutions described herein can be performed in a cloud-computing environment (e.g., comprising virtual machines and underlying infrastructure resources).

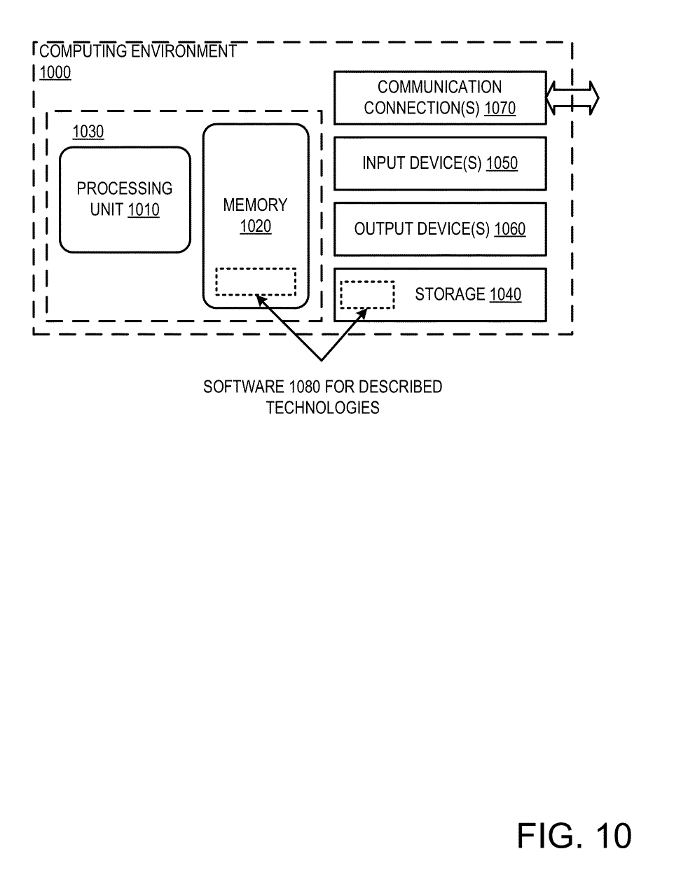

FIG. 10 illustrates a generalized example of a suitable computing environment 1000 in which described embodiments, techniques, and technologies can be implemented. The computing environment 1000 is not intended to suggest any limitation as to scope of use or functionality of the technology, as the technology can be implemented in diverse general-purpose or special-purpose computing environments. For example, the disclosed technology can be implemented using one or more computing devices (e.g., a server, desktop, laptop, hand-held device, mobile device, smartphone) each comprising a processing unit, memory and storage storing computer-executable instructions implementing the technologies described herein. The disclosed technology can also be implemented with other computer system configurations, including multiprocessor systems, microprocessor-based or programmable consumer electronics, network PCs, minicomputers, mainframe computers, a collection of client/server systems and the like. The disclosed technology can also be practiced in distributed computing environments where tasks are performed by remote processing devices that are linked through a communications network, such as the Internet. In a distributed computing environment, program modules can be located in both local and remote memory storage devices.

With reference to FIG. 10, the computing environment 1000 includes at least one central processing unit 1010 and memory 1020. In FIG. 10, this most basic configuration 1030 is included within a dashed line. The central processing unit 1010 executes computer-executable instructions. In a multi-processing system, multiple processing units execute computer-executable instructions to increase processing power and as such, multiple processors can be running simultaneously. The memory 1020 can be volatile memory (e.g., registers, cache, RAM), non-volatile memory (e.g., ROM, EEPROM, flash memory, etc.), or some combination of the two. The memory 1020 stores software 1080 that can, for example, implement the technologies described herein. A computing environment can have additional features. For example, the computing environment 1000 includes storage 1040, one or more input devices 1050, one or more output devices 1060 and one or more communication connections 1070. An interconnection mechanism (not shown) such as a bus, a controller, or a network, interconnects the components of the computing environment 1000. Typically, operating system software (not shown) provides an operating environment for other software executing in the computing environment 1000, and coordinates activities of the components of the computing environment 1000.

The storage 1040 can be removable or non-removable, and includes magnetic disks, magnetic tapes or cassettes, CD-ROMs, CD-RWs, DVDs, or any other tangible storage medium which can be used to store information and which can be accessed within the computing environment 1000. The storage 1040 stores instructions for the software 1080, which can implement technologies described herein.

The input device(s) 1050 can be a touch input device, such as a keyboard, keypad, mouse, touchscreen, pen, or trackball, a voice input device, a scanning device, or another device, that provides input to the computing environment 1000. For audio, the input device(s) 1050 can be a sound card or similar device that accepts audio input in analog or digital form, or a CD-ROM reader that provides audio samples to the computing environment 1000. The output device(s) 1060 can be a display, printer, speaker, CD-writer or another device that provides output from the computing environment 1000.

The communication connection(s) 1070 enable communication over a communication medium (e.g., a connecting network) to other computing entities. The communication medium conveys information such as computer-executable instructions, compressed graphics information or other data in a modulated data signal.

### Methods in Computer-Readable Media

In any of the examples described, Any of the disclosed methods can be implemented as computer-executable instructions or a computer program product stored on one or more computer-readable storage media (e.g., non-transitory computer-readable media, such as one or more optical media discs such as DVD or CD, volatile memory components (such as DRAM or SRAM), or nonvolatile memory components (such as hard drives)) and executed on a computer (e.g., any commercially available computer, including smart phones or other mobile devices that include computing hardware). Computer-readable media does not include propagated signals. Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

### Definitions

As used in this application and in the claims, the singular forms “a,” “an,” and “the” include the plural forms unless the context clearly dictates otherwise. Similarly, the word “or” is intended to include “and” unless the context clearly indicates otherwise. The term “comprising” means “including;” hence, “comprising A or B” means including A or B, as well as A and B together. Additionally, the term “includes” means “comprises.”

Additionally, the description sometimes uses terms like “produce” and “provide” to describe the disclosed methods. These terms are high-level abstractions of the actual computer operations that are performed. The actual computer operations that correspond to these terms will vary depending on the particular implementation and are readily discernible by one of ordinary skill in the art.

### Alternatives

The disclosed methods, apparatuses and systems should not be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation. In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope of these claims.

We claim:

1. A computer-implemented method of assessing the maturity of an organization's green computing efforts, the method comprising:
receiving green computing practice data indicating whether the organization has implemented one or more green computing practices out of a plurality of green computing practices, the one or more green computing practices associated with a plurality of green computing pillars, the plurality of green computing pillars comprising at least a people practices pillar or an IT services management pillar;
determining a plurality of competency levels for the plurality of green computing pillars based at least in part on the green computing practice data;
determining a green IT maturity level based on the plurality of competency levels; and
selecting one or more recommended green computing initiatives from a green computing initiative database based on the plurality of competency levels.

2. The method of claim 1, further comprising:
receiving IT inventory data; and
determining a carbon emission reduction estimate for at least one of the one or more recommended green computing initiatives based at least in part on the IT inventory data.

3. The method of claim 2, wherein the sum of the carbon emission reduction estimates is greater than or equal to a carbon emission reduction goal.

4. The method of claim 2, further comprising determining an estimated implementation cost for at least one of the one or more recommended green computing initiatives.

5. The method of claim 2, further comprising determining an estimated cost savings for at least one of the one or more recommended green computing initiatives.

6. The method of claim 1, wherein the plurality of green computing pillars comprises a people practices pillar.

7. The method of claim 1, wherein the plurality of green computing pillars comprises an IT asset lifecycle pillar.

8. The method of claim 1, wherein the plurality of green computing pillars comprises an IT service management pillar

9. The method of claim 1, wherein the plurality of green computing pillars comprises a people practices pillar, an IT asset lifecycle pillar, an end user computing pillar, a data center pillar and an IT service management pillar.

10. The method of claim 1, wherein the plurality of green computing practices is associated with a plurality of green computing practice areas, at least one of the plurality of green computing practice areas having a weighting, the determining the plurality of competency levels based in further part on the weighting.

11. The method of claim 1, wherein respective of the plurality of green computing pillars are associated with a plurality of green computing practices, respective of the plurality of green computing practices associated with a competency level, the determining a plurality of competency levels for the plurality of green computing pillars comprising determining whether the green computing practices associated with at least one of the plurality of competency levels for respective of the green computing pillars is satisfied based at least in part on the green computing practice data.

12. The method of claim 1, further comprising calculating an estimated reduction in carbon emissions based on the green computing practice data, wherein the determining the plurality of competency levels is based at least in part on the estimated reduction in carbon emissions.

13. The method of claim 1, further comprising implementing at least one of the one or more recommended green computing initiatives.

14. One or more computer-readable storage media storing computer-executable instructions for causing a computer to perform a method, the method comprising:
receiving green computing practice data indicating whether an organization has implemented a plurality of green computing practices, the plurality of green computing practices associated with a plurality of green computing pillars;
determining a plurality of competency levels for the plurality of green computing pillars based at least in part on the green computing practice data;
determining a green IT maturity level based on the plurality of competency levels; and
selecting one or more recommended green computing initiatives from a green computing initiative database based on the plurality of competency levels.

15. The one or more computer-readable storage media of claim 13, the method further comprising:
receiving IT inventory data; and
determining a carbon emission reduction estimate for at least one of the one or more recommended green computing initiatives based at least in part on the IT inventory data.

16. The one or more computer-readable storage media of claim 13, wherein the plurality of green computing pillars comprises a people practices pillar.

17. The one or more computer-readable storage media of claim 13, wherein the plurality of green computing pillars comprises an IT asset lifecycle pillar.

18. At least one computer programmed to carry out a method, the method comprising:
using the at least one computer:
receiving a carbon emission reduction goal;
receiving green computing practice data indicating whether an organization has implemented a plurality of green computing practices, the plurality of green computing practices associated with a plurality of green computing pillars;
determining a plurality of competency levels for the plurality of green computing pillars based at least in part on the green computing practice data;
determining a green IT maturity level based on the plurality of competency levels; and
selecting one or more recommended green computing initiatives from a green computing initiative database based on the plurality of competency levels and the carbon emissions reduction goal.

19. The at least one computer of claim 18, the method further comprising receiving a budget constraint, the selecting one or more recommended green computing initiatives further based on the budget constraint.

20. The computer of claim 18, the method further comprising updating the green computing initiative database, the updating comprising adding one or more green computing initiatives to the green computing initiative database.

21. The computer of claim 18, the method further comprising, in response to the adding one or more green computing initiatives to the green computing database:
redetermining the plurality of competency levels for the plurality of green computing pillars based at least in part on the green computing practice data;
redetermining the green IT maturity level based on the plurality of competency levels; and
reselecting one or more recommended green computing initiatives from the updated green computing initiative database based on the plurality of competency levels and the carbon emissions reduction goal.
